(19) United States
(12) Patent Application Publication
(10) Pub. No.: US 2016/0154183 A1
(43) Pub. Date: Jun. 2, 2016

(54) MEMS OPTICAL SWITCH

(71) Applicant: OPLINK COMMUNICATIONS, INC., Fremont, CA (US)

(72) Inventors: Jian ZHOU, Zhuhai, Guangdong (CN); Jun LI, Zhuhai, Guangdong (CN); Zhidong LIU, Zhuhai, Guangdong (CN); Kesheng XU, San Ramon, CA (US); Pei ZHU, Zhuhai, Guangdong (CN)

(73) Assignee: Oplink Communications, Inc., Fremont, CA (US)

(21) Appl. No.: 14/900,412

(22) PCT Filed: Jun. 27, 2013
(86) PCT No.: PCT/CN2013/078146

§ 371 Date: Dec. 21, 2015

(51) Int. Cl. G02B 6/35; G02B 6/38; G02B 6/32

(52) U.S. Cl. CPC G02B 6/3518; G02B 6/3546; G02B 6/32; G02B 6/3885; G02B 6/3586

(57) ABSTRACT

Methods, systems, and apparatus, including computer programs encoded on computer storage media, for optical switching. One of the optical switches includes a plurality of optical fibers positioned in an array, the plurality of fibers including one or more input fibers and a plurality of output fibers; a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers according to a switch trajectory that does not traverse over any other fiber of the plurality of fibers.

### BACKGROUND

This specification relates to optical communications.

An optical switch is a switch that enables optical signals of one or more input optical fibers to be selectively switched to one of multiple output optical fibers or reciprocally switching from multiple input fibers to a common output fiber. Conventional optical switches can implement switching using various structures including mechanical, electro-optic, or magneto-optic switching.

### SUMMARY

In general, one innovative aspect of the subject matter described in this specification can be embodied in optical switches that include multiple optical fibers positioned in an array, the multiple fibers including one or more input fibers and multiple output fibers; a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers according to a switch trajectory that does not traverse over any other fiber of the plurality of fibers.

The foregoing and other embodiments can each optionally include one or more of the following features, alone or in combination. The switch trajectory traverses a clearance space between fibers of the multiple fibers. The switch trajectory comprises multiple discrete path segments. The path segments are traversed sequentially in the switch trajectory and are each defined by a corresponding endpoint location in the array. One or more of the endpoint locations are between output fibers. The multiple optical fibers are positioned within a ferrule. The optical switch further includes a lens positioned between the multiple optical fibers and the MEMS mirror. The optical switch further includes a control circuit for controlling the MEMS mirror. The control circuit stores multiple switch trajectories for switching between any two output fibers of the multiple output fibers. The multiple fibers are arranged to provide a specified distance between input fibers and output fibers. The multiple fibers are arranged within a glass ferrule including multiple unused fibers positioned to create the specified distance between input fibers and output fibers. The multiple fibers are arranged within a glass ferrule having two distinct bores separated by the specified distance. The MEMS mirror includes an actuator configured to adjust the MEMS mirror along an x and y axis independently according to an applied voltage. The control circuit provides one or more x, y voltage pairs to the MEMS mirror to change the MEMS mirror position.

In general, one innovative aspect of the subject matter described in this specification can be embodied in methods that include the actions of positioning a microelectromechanical (MEMS) mirror to direct an optical signal received from a first input fiber to output at a first output fiber; receiving input to switch the optical signal to output at a second output fiber; determining a switch trajectory for moving the MEMS mirror to direct light from the first output fiber to the second output fiber without passing over another output fiber; and moving the MEMS mirror according to the determined switch trajectory.

The foregoing and other embodiments can each optionally include one or more of the following features, alone or in combination. Determining the switch trajectory includes looking up a pre-determined switch trajectory corresponding to the first and second output fibers. The switch trajectory includes a plurality of sequential path segments, and wherein moving the MEMS mirror according to the determined switch trajectory includes sequentially applying x, y voltage pairs to the MEMS mirror corresponding to each path segment endpoint. Determining the switch trajectory includes calculating a plurality of path segments along a number of points to generate a hitless switch trajectory from the first output fiber to the second output fiber. The method further includes calibrating the MEMS mirror including determining x, y voltages applied to the MEMS mirror that correspond to the first and second output fibers, respectively.

A microelectromechanical (MEMS) optical switching structure is provided. The MEMS switch includes an array of fibers, a focusing lens, and a MEMS mirror. In some implementations, a light beam can be switched from a first output fiber to a second output fiber. Switching is provided by changing one or more rotational angles of the MEMS mirror to direct an input light beam to a particular output fiber. When changing the rotational angles of the MEMS mirror, a switching trajectory is applied that uses a number of path segments that route the light beam from the first output fiber to the second output fiber without being incident on other fibers of the array.

Particular embodiments of the subject matter described in this specification can be implemented so as to realize one or more of the following advantages. A switch trajectory that a light beam traverses during switching from one output fiber to another output fiber is configured to avoid light impinging on unintended optical fibers, thereby improving operation of an optical communication system. Additionally, optical fibers are arranged such that input and output fibers are separated by a specified distance to avoid signal interference. Input and output fibers are arranged in a dense, tight, rectangular array, which prevents movement of fibers under adverse conditions, to enhance the reliability of the optical switch. The lens can be sealed into switch package, e.g., into the TO-Can cap, to avoid conventionally used optical windows.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example MEMS optical switch.

FIG. 2 is an example fiber array.

FIG. 3 is an example fiber array including control points for determining a switching trajectory.

FIG. 4 is an example MEMS switching system.

FIG. 5 is a flow diagram of an example method for optical switching.

FIG. 6 is an illustration of example spacing distances between fibers in an array.

FIG. 7 is an example ferrule for a 12×1 optical switch.

FIG. 8 is another example ferrule for a 12×1 optical switch.

FIG. 9 is an example ferrule having separate fiber bores.

FIG. 10 is an example switch package.

Like reference numbers and designations in the various drawings indicate like elements.

### DETAILED DESCRIPTION

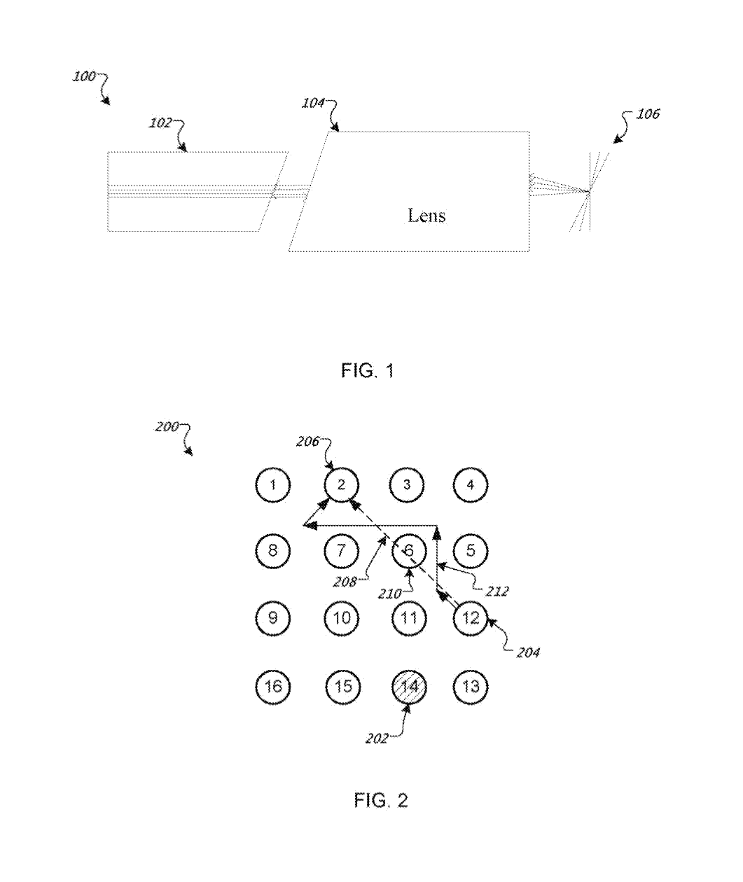

FIG. 1 is an example MEMS optical switch 100. The MEMS optical switch 100 includes multiple optical fibers held in a ferrule 102, a lens 104, and a MEMS mirror 106.

The multiple optical fibers can be fiber pigtails arranged in an N×M rectangular array. The fiber pigtails can be divided into two groups. A first group of fiber pigtails are used as an input fiber while the second group of fiber pigtails corresponds to output fibers. In some implementations, one or more of the multiple optical fibers can be unused fibers.

The lens 104 collimates light signals received from the input fibers and collimates reflected light signals from the MEMS mirror 106 and directs the reflected light signals to a particular output fiber. Light from an input fiber can be selectively directed to any output fiber forming a 1×L optical switch where L is the number of output fibers in the N×M array. Similarly, the same structure can be used to form an L×1 MEMS optical switch in which light from multiple input fibers are routed to an output fiber.

The MEMS mirror 106 can rotate to specific positions in response to control signals (e.g., particular applied voltages as described in greater detail below). For example, the MEMS mirror 106 includes an actuator used to drive a rotation of the mirror surface along x and y axes independently within a specified angular degree range. An input light beam that is incident on the mirror surface will be reflected through the lens 104 where it is focused on a particular output fiber depending on the x and y angular positions of the MEMS mirror 106.

FIG. 2 is an example fiber array 200. The fiber array 200 is a 4×4 rectangular arrangement. The fibers can be pigtails positioned within a ferrule. Each fiber is numbered from 1 to 16. In general, one or more of the fibers can be input fibers while other fibers are output fibers. For example, fibers 1-12 can be selectable output fibers. Additionally, in some implementations, there can be one or more unused fibers in the fiber array 200.

In this example, the fibers include an input fiber 202 and a first output fiber 204. Thus, a light beam input from fiber 202 is reflected by the MEMS mirror surface (FIG. 1) and directed to the first output fiber 204. Additionally, the example fiber array 200 shows a second output fiber 206. In response to a command, the input light beam from input fiber 202 can be switched from the first output fiber 204 to the second output fiber 206. To perform the switching, the x and y angular positions of the MEMS mirror are modified so that the input light beam is focused on the location of the second output fiber 206 instead of the location of the first output fiber 204.

In some implementations, the switching is performed by changing the x and y angular positions of the MEMS mirror directly using the shortest amount of angular movement to the mirror surface necessary to shift the light beam to the target output fiber. For example, the reflected light beam can traverse a straight line from the first output fiber 204 to the second output fiber 206 as the MEMS mirror is adjusted. However, such an implementation often results in “hitting” of unintended optical fibers. Hitting refers to at least a portion of the light beam, either directly or through refraction, leaking into an optical fiber that is not the target output fiber. For example, referring to the fiber array 200, one switch trajectory from the first output fiber 204 to the second output fiber 206 is shown by dashed line 208. However, this switch trajectory causes the light beam to pass across output fiber 210 as the light beam traverses from being directed to the first output fiber 204 to being directed to the second output fiber 206. This leaking of the light beam into the unintended optical fiber results in the fiber 210 being referred to as “hit.”

In some other implementations, the path from the first output port 204 to the second output port 206 is controlled to avoid light leakage into unintended optical fibers. The switch trajectory of the light beam is controlled such that it passes through a clearance space between any two fibers and/or completely outside of the range of any fibers and therefore avoids a hit to any unintended port. In particular, as shown by path 212, the x and y angular rotation positions of the MEMS mirror are controlled to follow a switching trajectory, having a number of discrete path segments, that avoids other optical fibers along the switch trajectory from the first output fiber 204 to the second output fiber 206.

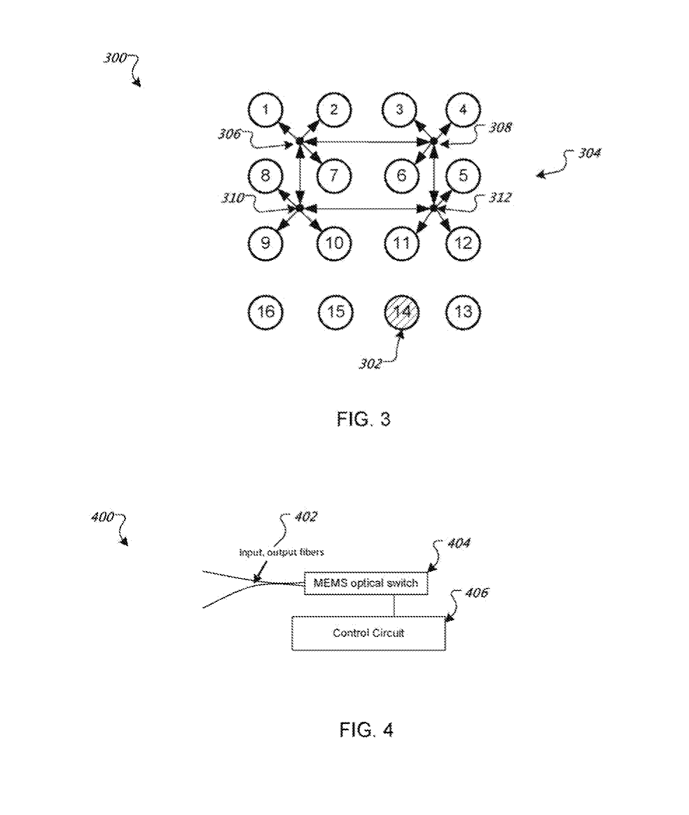

FIG. 3 is an example fiber array 300 including control points for determining a switching trajectory. The fiber array 300 includes a 4×4 rectangular arrangement, for example, similar to fiber pigtail arrangement of FIG. 2. Each fiber is numbered from 1 to 16. In general, one or more of the fibers can be input fibers while other fibers are output fibers. Additionally, in some implementations, there can be one or more unused fibers in the fiber array.

In the fiber array 300, a trajectory selection of a 1×12 switch is shown. An input fiber 302 is located at fiber number 14 while fibers 1-12 are output fibers 304. Fibers 13, 15, and 16 can be unused fibers or alternative input fibers.

A MEMS switch can be calibrated such that particular voltage values, e.g., an x, y voltage pair, applied to the MEMS mirror, can cause the MEMS mirror to be positioned at coordinates that direct a reflected input light beam to a corresponding output fiber of the output fibers 304. Thus, for the 12 output fibers 304, there are 12 corresponding voltage pairs. The x, y voltage pairs for each output fiber location can be pre-calibrated for the MEMS switch and stored for use in switching between output fibers. Additional calibrations can be made for x, y voltage pairs when a different fiber input is used.

In addition to the 12 voltage pairs for the corresponding output fibers 304, four additional voltage pairs can be calibrated to correspond to other points relative to the output fibers 304. In particular, the fiber array 300 shows four points centered among four groups of output fibers: center point 306 among fibers 1, 2, 7, and 8; center point 308 among fibers 3, 4, 5, and 6; center point 310 among fibers 7, 8, 9, and 10; and center point 312 among fibers 5, 6, 11, and 12. The locations of the points 306, 308, 310, and 312 can also be pre-calibrated and stored.

Using these four points 306, 308, 310, and 312, hitless switch trajectories can be determined for switching between any two of the 12 output fibers 304. For example, switching from fiber 1 to fiber 6 can follow a switch trajectory having several discrete path segments: a path segment from fiber 1 to point 306, a path segment from point 306 to point 308, and a path segment from point 308 to fiber 6. Each path segment in the switch trajectory can use the clearance space between fibers. The switch trajectory can be defined by a sequence of voltage pairs corresponding to each path segment endpoint on the switch trajectory. In some implementations, each possible switch trajectory for a given fiber array can be predetermined and stored, e.g., in association with a control circuit for the MEMS switch. When switching between output fibers, the appropriate switch trajectory can be identified and executed as a sequence of voltage commands to the MEMS mirror.

FIG. 4 is an example MEMS switching system 400. The MEMS switching system 400 include input and output fibers 402, a MEMS optical switch 404, and a control circuit 406. The MEMS optical switch 404 can be implemented as described above with respect to FIGS. 1-3. The input and output fibers 402 provide the input and output paths, respectively, for the fiber pigtails of the MEMS optical switch 404. The control circuit 406 can include voltage calibration data and switching trajectory data for points of the fiber array in the MEMS optical switch 404. The calibration and switching trajectory data including intermediate points positioned between output fibers. Thus, the control circuit 406 can provide appropriate switching signals to the MEMS mirror for accurately switching between output ports.

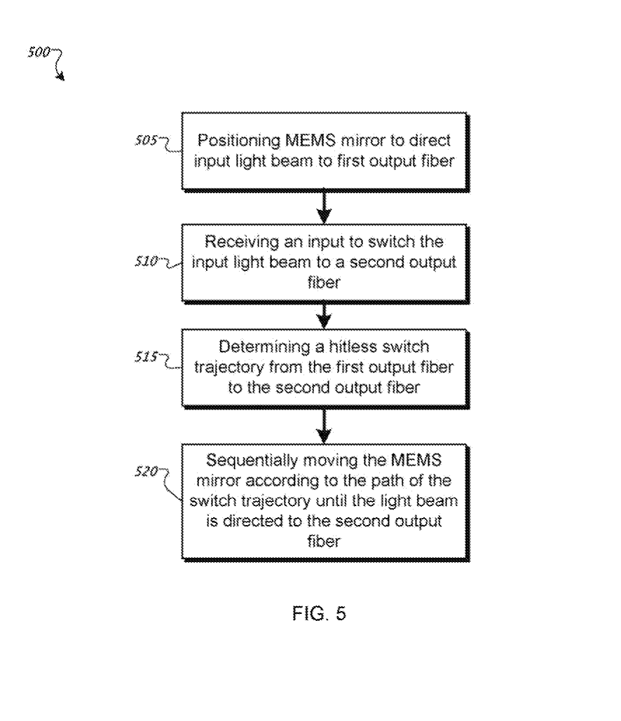

FIG. 5 is a flow diagram of an example method 500 for optical switching. Optical switching can be performed by a MEMS optical switching system, for example, as described in FIGS. 1-4 above.

A MEMS mirror is positioned to direct an input light beam to a first output fiber (505). A particular voltage can be applied to control x and y axes, respectively, of the MEMS mirror in order to direct the reflection of the input beam to the location of the first output fiber.

An input is received to switch the input light beam to a second output fiber (510). The input can be received, for example, from a computer system for an optical communications network.

A hitless switch trajectory from the first output fiber to the second output fiber is determined (515). In some implementations, the hitless switch trajectories have been predetermined using calibrated points. Alternatively, in some other implementations the hitless switch trajectories are calculated at the time of the switching based on stored calibration data. For example, using calibration data specifying the locations of the output fibers as well as one or more intermediate points between output fibers, path segments for a switching trajectory between output fibers can be determined. The path segments follow a clearance space between fibers such that no path segments cross optical fibers. The collection of path segments between a pair of output fibers form the switching trajectory. Predetermined switching trajectories between specific fibers can be stored for retrieval upon an input to switch output fibers.

The MEMS mirror is moved sequentially according to the path segments of the switch trajectory until the light beam is directed to the second output fiber (520). In some implementations, a control circuit sends a sequence of voltage pairs corresponding to particular MEMS mirror positions associated with each path segment endpoint.

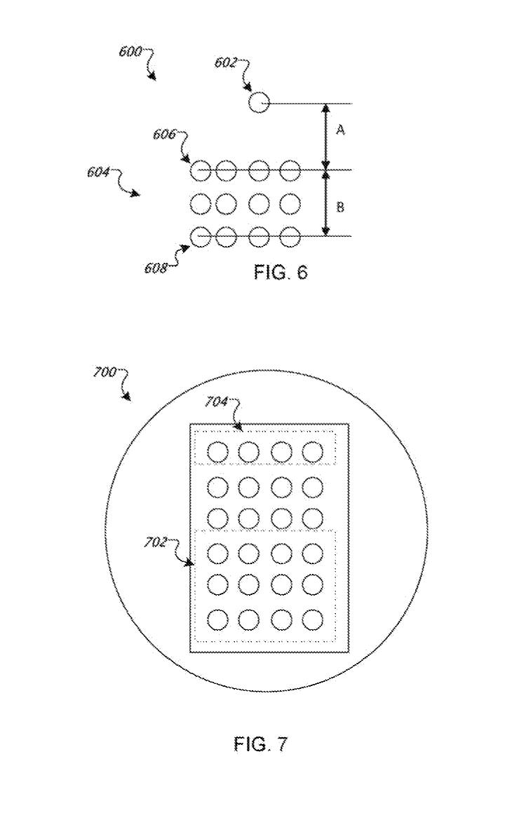

FIG. 6 is an illustration of example spacing distances between fibers in a fiber array 600. If the separating distance between input fibers and output fibers is unregulated, signal interference can occur. For example, when a switch is an L×1 switch, there are L input fibers in the fiber array. Each of the L input fibers can have emitted light signals. In some switch states, it is possible that one or more input fibers receive reflected light. This causes light signals from an input fiber to transmit backward into another input fiber, resulting in signal interference.

To avoid the potential signal interference, the distance between input and output fibers can be specified to substantially reduce or eliminate such interference. The array 600 includes a COM fiber 602 and 12 input fibers 604. In particular, by establishing the distance between the COM fiber and the nearest input fiber to be larger than the distance between the two outermost input fibers, the signal interference may be avoided. Thus, as shown in array 600, the distance “A” corresponds to the distance between the COM fiber 602 and the closest input fibers 606, e.g., from fiber center to fiber center. The distance “B” corresponds to the distance between the outermost input fibers 608, e.g., from fiber center to fiber center. When A is greater than B, signal interference may be avoided. In some implementations, when A>B+20 □ m, interference avoidance is further improved.

The particular distances can be established using a ferrule structure. FIG. 7 illustrates an example 4×6 glass ferrule 700 for use in implementing a 12×1 optical switch. As shown in FIG. 7, 12 fibers inside a first dotted line 702 are selectively used as input ports while any one of the four fibers inside a second dotted line 704 can selectively be the COM port. The fibers inside the first dotted line 702 are separated from the fibers within the second dotted line 704, for example, by unused fibers. The arrangement is structured so that distance from the fibers of the second dotted line 704 to the first row of fibers within the first dotted line 702 is greater than the distance between the outermost input fibers within the first dotted line 702.

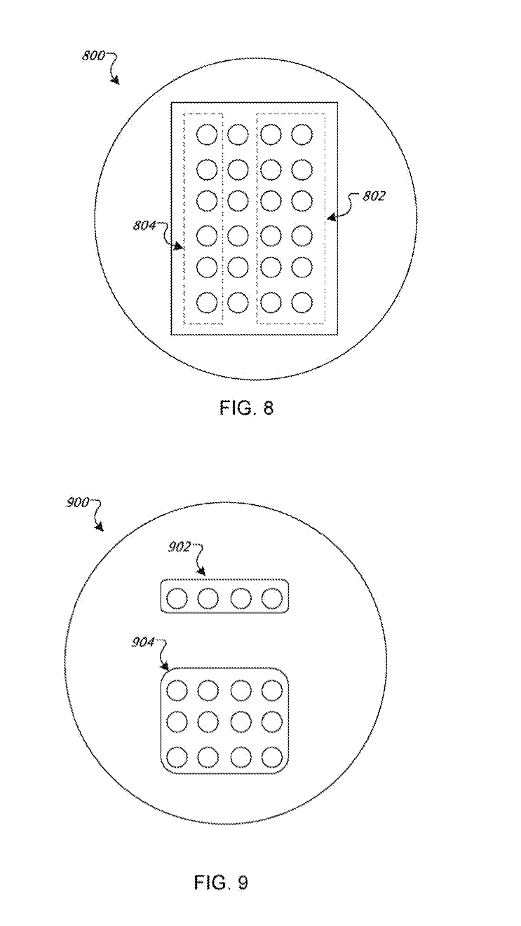

FIG. 8 illustrates an example 4×6 glass ferrule 800 for use in implementing a 12×1 optical switch. As shown in FIG. 8, 12 fibers inside a first dotted line 802 are selectively used as input ports while any one of the four fibers inside a second dotted line 804 can selectively be the COM port. The fibers inside the first dotted line 802 are separated from the fibers within the second dotted line 804, for example, by unused fibers. The arrangement is structured so that the distance from the fibers of the second dotted line 804 to the first row of fibers within the first dotted line 802 is greater than the distance between the outermost input fibers within the first dotted line 802.

FIG. 9 is another example ferrule 900 having separate fiber bores. The ferrule 900 includes two separate bores. The first bore 902 is used for COM fibers and the second bore 904 is used for input fibers. For example, similar to the ferrule of FIG. 7, the second bore 904 can include 12 input fibers selectively used as input ports and the second bore 902 can include four fibers that can selectively be used as the COM port. If the distance between the two bores is large enough, e.g., satisfying the above condition of A>B, the ferrule 900 can be used in the 12×1 MEMS switch without the input fiber ports cross interferences problem.

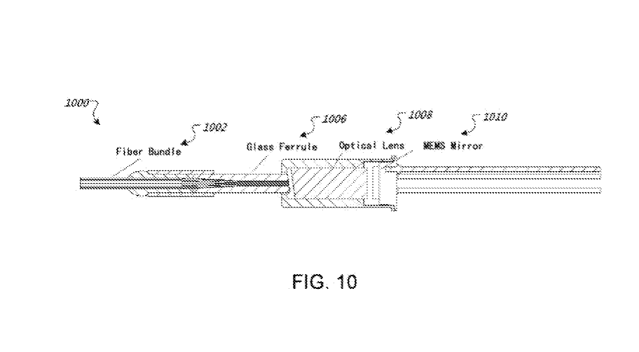

FIG. 10 is an example switch package 1000. The switch package 1000 includes a fiber bundle 1002, a fiber pigtail including a glass ferrule 1006, an optical lens 1008, and a MEMS mirror 1010. The switch package 1000 can be coupled to an optical fiber bundle in an optical communications system.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An optical switch comprising:
a plurality of optical fibers positioned in an array, the plurality of fibers including one or more input fibers and a plurality of output fibers;
a microelectromechanical (MEMS) mirror configured to controllably reflect light from an input fiber to a particular target output fiber of the plurality of output fibers, wherein a position of the MEMS mirror is controllable to switch from a first target output fiber to a second target output fiber of the plurality of output fibers according to a switch trajectory that does not traverse over any other fiber of the plurality of fibers.

2. The optical switch of claim 1, wherein the switch trajectory traverses a clearance space between fibers of the plurality of fibers.

3. The optical switch of claim 2, wherein the switch trajectory comprises a plurality of discrete path segments.

4. The optical switch of claim 2, wherein the path segments are traversed sequentially in the switch trajectory and are each defined by a corresponding endpoint location in the array.

5. The optical switch of claim 4, where one or more of the endpoint locations are between output fibers.

6. The optical switch of claim 1, wherein the plurality of optical fibers are positioned within a ferrule.

7. The optical switch of claim 1, further comprising a lens positioned between the plurality of optical fibers and the MEMS mirror.

8. The optical switch of claim 1, further comprising a control circuit for controlling the MEMS mirror.

9. The optical switch of claim 8, wherein the control circuit stores a plurality of switch trajectories for switching between any two output fibers of the plurality of output fibers.

10. The optical switch of claim 1, wherein the plurality of fibers are arranged to provide a specified distance between input fibers and output fibers.

11. The optical switch of claim 10, wherein the plurality of fibers are arranged within a glass ferrule including a plurality of unused fibers positioned to create the specified distance between input fibers and output fibers.

12. The optical switch of claim 10, wherein the plurality of fibers are arranged within a glass ferrule having two distinct bores separated by the specified distance.

13. The optical switch of claim 1, wherein the MEMS mirror includes an actuator configured to adjust the MEMS mirror along an x and y axis independently according to an applied voltage.

14. The optical switch of claim 13, wherein the control circuit provides one or more x, y voltage pairs to the MEMS mirror to change the MEMS mirror position.

15. A method comprising:
positioning a microelectromechanical (MEMS) mirror to direct an optical signal received from a first input fiber to output at a first output fiber;
receiving input to switch the optical signal to output at a second output fiber;
determining a switch trajectory for moving the MEMS mirror to direct light from the first output fiber to the second output fiber without passing over another output fiber; and
moving the MEMS mirror according to the determined switch trajectory.

16. The method of claim 15, wherein determining the switch trajectory includes looking up a pre-determined switch trajectory corresponding to the first and second output fibers.

17. The method of claim 16, wherein the switch trajectory includes a plurality of sequential path segments, and wherein moving the MEMS mirror according to the determined switch trajectory includes sequentially applying x, y voltage pairs to the MEMS mirror corresponding to each path segment endpoint.

18. The method of claim 15, wherein determining the switch trajectory includes calculating a plurality of path segments along a number of points to generate a hitless switch trajectory from the first output fiber to the second output fiber.

19. The method of claim 15 further comprising calibrating the MEMS mirror including determining x, y voltages applied to the MEMS mirror that correspond to the first and second output fibers, respectively.
